(19) United States
(12) Patent Application Publication
(10) Pub. No.: US 2022/0274656 A1
(43) Pub. Date: Sep. 1, 2022

(54) Two-way Foldable Spare Tire Rack for Vehicle

(71) Applicant: Huatao Chen, Ruian (CN)

(72) Inventor: Huatao Chen, Ruian (CN)

(21) Appl. No.: 17/748,087

(22) Filed: May 19, 2022

(51) Int. Cl. B62D 43/02

(52) U.S. Cl. CPC B62D 43/02

(57) ABSTRACT

Disclosed is a two-way foldable spare tire rack for a vehicle comprises a fixed frame assembly and a movable bar frame assembly, wherein the fixed frame assembly comprises a positioning joint pipe, a support pipe arranged above the positioning joint pipe, a rotating member and a rotation limiting member, wherein the positioning joint pipe and the support pipe form a rotatable structure through the rotating member, and the rotation limiting member is used for limiting the rotation between the support pipe and the positioning joint pipe to keep them in the use state; a long bracket pipe is fixed above the support pipe, and a bracket plate is fixed at the free end of the long bracket pipe; the movable bar frame assembly comprises an adjusting plate, a movable square pipe and at least one locking member which are rotationally connected, wherein the adjusting plate is fixedly connected to one side of the positioning joint pipe, and the locking member is used for locking the adjusting plate and the movable square pipe in the use state; the fixed frame assembly and the movable bar frame assembly of the vehicle spare tire rack can be folded, the movable bar frame assembly is convenient for packaging and delivery through folding, and the fixed frame assembly is convenient for the spare tire on the bracket plate to be transferred to contact with the ground surface and then disassembled, so that the disassembly and assembly are convenient.

### TECHNICAL FIELD

The present disclosure relates to a two-way foldable spare tire rack for a vehicle.

### BACKGROUND

Spare tire refers to the spare tire of the car, which is used to prevent the tire burst and air leakage while the car is driving, and avoid the inconvenience caused by the anchor halfway; For most large SUVs, RVs, etc., a tow bar is set at the rear of the chassis, and the owner can configure the spare tire rack according to the needs. The spare tire rack is fixedly connected to the tow bar, and the spare tire is mounted on the spare tire rack to solve the trouble of traveling.

The existing spare tire racks are basically rigid, so it is inconvenient to pack and deliver the rigid spare tire racks. At the same time, after the rigid spare tire racks are fixedly installed, it is very laborious to disassemble the spare tires on the spare tire racks, especially for female drivers.

### SUMMARY

In view of the shortcomings of the above problems, the present disclosure provides a two-way foldable spare tire rack for a vehicle.

In order to achieve the above purpose, the present disclosure provides a two-way foldable spare tire rack for a vehicle, which includes a fixed frame assembly for fixing a spare tire and a movable bar frame assembly arranged at one side of the fixed frame assembly, characterized in that: the fixed frame assembly comprises a positioning joint pipe, a support pipe arranged above the positioning joint pipe, a rotating member and a rotation limiting member, wherein the positioning joint pipe and the support pipe form a rotatable structure through the rotating member, and the rotation limiting member is used for limiting the rotation between the support pipe and the positioning joint pipe to keep them in a use state; a long bracket pipe is fixed above the support pipe, and a bracket plate is fixed at a free end of the long bracket pipe; the movable bar frame assembly comprises an adjusting plate, a movable square pipe and at least one locking member which are rotationally connected, wherein the adjusting plate is fixedly connected to one side of the positioning joint pipe, and the locking member is used for locking the adjusting plate and the movable square pipe in the use state.

The fixed frame assembly and the movable bar frame assembly of the vehicle spare tire rack can be folded, the movable bar frame assembly is convenient for packaging and delivery through folding, and the fixed frame assembly is convenient for the spare tire on the bracket plate to be transferred to contact with the ground surface and then disassembled, which is convenient and labor-saving.

As a further improvement of the solution, the rotating member and the rotation limiting member are bolts of a same size, and the positioning joint pipe and the support pipe are provided with an upper hole position and a lower hole position at the overlapping position that are perforative for two bolts to pass through.

In the technical solution, one bolt penetrates the lower hole to be used as a rotating shaft, so that a rotating structure is formed, and the other bolt penetrates the upper hole to achieve a limiting effect.

As a further improvement of the solution, the cross-sectional size of the support pipe is smaller than that of the positioning joint pipe, the cross-sectional size of the long bracket pipe is consistent with that of the positioning joint pipe, and an upper end of the positioning joint pipe is also provided with a reinforcing plate with a U-shaped cross section, and the upper hole position and the lower hole position simultaneously penetrate through the reinforcing plate.

In the above technical solution, the support pipe and the positioning joint pipe are in a rotating structure, and there is bound to be a difference in size. The difference in size makes the rotation of the support pipe offset to a certain extent. The support pipe is designed to be smaller than that of the positioning joint pipe, and the reinforcing plate is configured to eliminate the offset of the two rotation, so that the rotation is more stable.

As a further improvement of the solution, the overlapping position of the long support pipe and the reinforcing plate is processed with a rotation limiting hole position for one of the bolts to pass through.

In the above technical solution, the rotation limiting hole position is perpendicular to the upper hole position or the lower hole position, and the mode of one bolt directly penetrating the rotation limiting hole position and one bolt penetrating the upper hole position is more stable than the mode of two bolts penetrating the upper and lower holes respectively.

As a further improvement of the solution, the nut of one of the bolts can be welded on the side of the reinforcing frame.

In the above technical solution, in the folding process of the fixed frame assembly, the screw of the redundant bolt can be directly screwed on the welded nut to avoid losing, but the rotation of the fixed frame assembly needs to be locked, and the screw of the bolt only needs to be screwed into the rotation limiting hole, while the other end does not need the nut.

As a further improvement of the solution, there are two locking members, and when in use, the two locking members pass through the overlapping part of the adjusting plate and the movable square pipe.

In the above technical solution, the connecting structure is more stable through the action of the two locking members.

As a further improvement of the solution, the movable square pipe or/and the adjusting plate is provided with a locking hole, and the locking member can be inserted in the position of the locking hole to lock the adjusting plate and the movable square pipe in a folded state.

In the above technical solution, the locking member is inserted into the locking hole, so that the folded movable bar frame assembly is stable.

As a further improvement of the solution, the movable square pipe is provided with a plurality of adjusting holes at equal intervals in the length direction;

In the technical solution, the movable square pipe is connected with the drag bar of the automobile chassis, and the adjusting hole is used for adjusting the distance to ensure that the trunk can be opened normally.

Compared with the prior art, the present disclosure has the beneficial effects that the fixed frame assembly and the movable bar frame assembly of the vehicle spare tire frame can be folded, the movable bar frame assembly is convenient for packaging and delivery through folding, and the fixed frame assembly is convenient for the spare tire on the bracket plate to be transferred to contact with the ground surface and then disassembled, so that disassembly and assembly are convenient and labor-saving.

### BRIEF DESCRIPTION OF DRAWINGS

FIG. 1 is a perspective view of a two-way foldable spare tire rack for a vehicle according to the present disclosure;

FIG. 2 is an exploded view of a two-way foldable spare tire rack for a vehicle of the present disclosure;

FIG. 3 is a schematic diagram of the folding of the fixed frame assembly;

FIG. 4 is a schematic diagram of the folding of the movable bar frame assembly.

In the FIGS.: 1. Bracket plate; 2. Long support pipe; 3. Support pipe; 4. Rotation limiting member; 5. Reinforcing plate; 6. Rotating member; 7. Positioning joint pipe; 8. Adjusting plate; 9. Movable square pipe; 91. Adjusting hole; 10. Locking member; 1a, Upper hole position; 1b. Lower hole position; 1c, Rotation limiting hole position; 1d. Locking hole.

### DESCRIPTION OF EMBODIMENTS

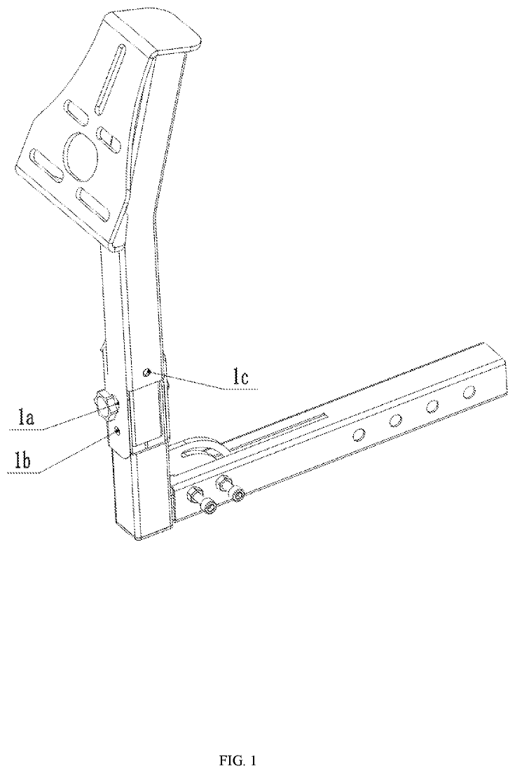

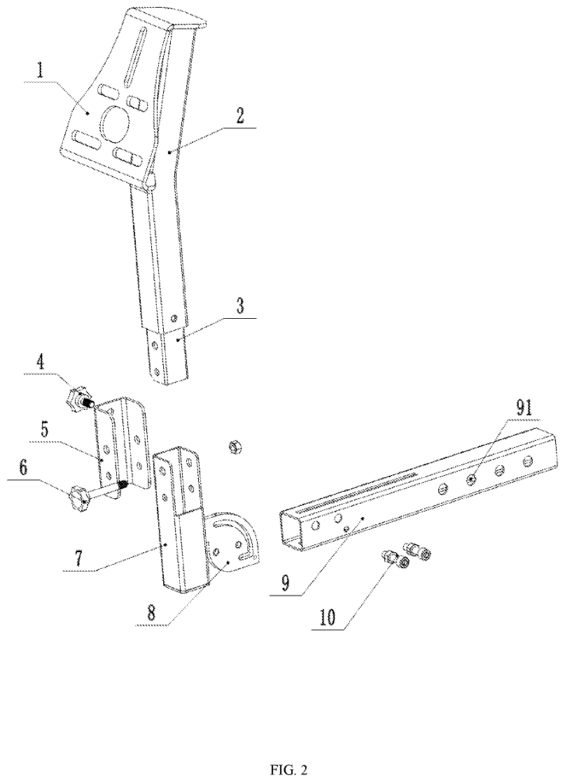

As shown in FIGS. 1-4, a two-way foldable spare tire rack for a vehicle according to the embodiment of the present disclosure includes a fixed frame assembly for fixing a spare tire and a movable bar frame assembly arranged at one side of the fixed frame assembly. The fixed frame assembly includes a positioning joint pipe 7, a support pipe 3 arranged above the positioning joint pipe 7, a rotating member 6, and a rotation limiter 4. The positioning joint pipe 7 and the support pipe 3 form a rotatable structure through the rotating member 6, and the rotation limiter 4 is used for limiting the rotation between the support pipe 3 and the positioning joint pipe 7. The movable bar frame assembly includes an adjusting plate 8, a movable square pipe 9 and at least one locking member 10 which are rotationally connected, wherein the adjusting plate 8 is fixedly connected to one side of the positioning joint pipe 7, and the locking member 10 is used for locking the adjusting plate 8 and the movable square pipe 9 in the use state; wherein the rotating member 6 and the rotation limiting member 4 are bolts of the same size, and the positioning joint pipe 7 and the support pipe 3 are provided with a upper hole 1a and a penetrating lower hole 1b at the overlapping position that are perforative for two bolts to pass through, one bolt passes through the lower hole to be used as a rotating shaft to form a rotating structure, and the other bolt passes through the upper hole to achieve a limiting effect; the cross-sectional size of the support pipe 3 is smaller than that of the positioning joint pipe 7, and the cross-sectional size of the long support pipe 2 is the same as that of the positioning joint pipe 7, and the upper end of the positioning joint pipe 7 is also provided with a reinforcing plate 5 with a U-shaped cross-section, and the upper hole position 1a and the lower hole position 1b penetrate through the reinforcing plate 5 at the same time. The support pipe and the positioning joint pipe are in a rotating structure, so there is bound to be a difference in size, and the difference in size makes the rotation of the two pipes deviate to a certain extent. Therefore, the size of the support pipe is designed to be smaller than that of the positioning joint pipe, and the function of the reinforcing plate is configured, so that the offset of the rotation of the two pipes is eliminated and the rotation is more stable. The overlapping position of the long support pipe 2 and the reinforcing plate 5 is provided with a rotation limiting hole 1c for one bolt to pass through, and the rotation limiting hole is perpendicular to the upper hole or the lower hole, so that the mode that one bolt directly passes through the rotation limiting hole and one bolt passes through the upper hole is more stable than the mode that two bolts respectively pass through the upper and lower holes. The nut of one of the bolts can be welded on the side of the reinforcing frame 5. During the folding process of the fixed frame assembly, the screw of the redundant bolt can be directly screwed on the welded nut to avoid loss. To lock the rotation of the fixed frame assembly, the screw of the bolt only needs to be screwed into the rotation limiting hole, while the other end does not need the nut. There are two locking members 10. When in use, the two locking members 10 pass through the overlapping part of the adjusting plate 8 and the movable square pipe 9, and the connecting structure is more stable through the action of the two locking members. The movable square pipe 9 or/and the adjusting plate 8 is provided with a locking hole 1d, and the locking member 10 can be inserted into the locking hole 1d to lock the adjusting plate 8 and the movable square pipe 9 in a folded state, and the folded movable bar frame assembly can be kept stable by inserting the locking member into the locking hole. The movable square pipe 9 is provided with a plurality of adjusting holes 91 at equal intervals in the length direction, and the movable square pipe is connected with the drag bar of the automobile chassis, and the adjusting holes are used for adjusting the distance to ensure that the trunk can be opened normally.

The fixed frame assembly and the movable bar frame assembly of the vehicle spare tire rack can be folded, the movable bar frame assembly is convenient for packaging and delivery through folding, and the fixed frame assembly is convenient for the spare tire on the bracket plate to be transferred to contact with the ground surface and then disassembled, which is convenient and labor-saving.

When in use, in order to facilitate the understanding of the present disclosure, it will be described with reference to the attached drawings.

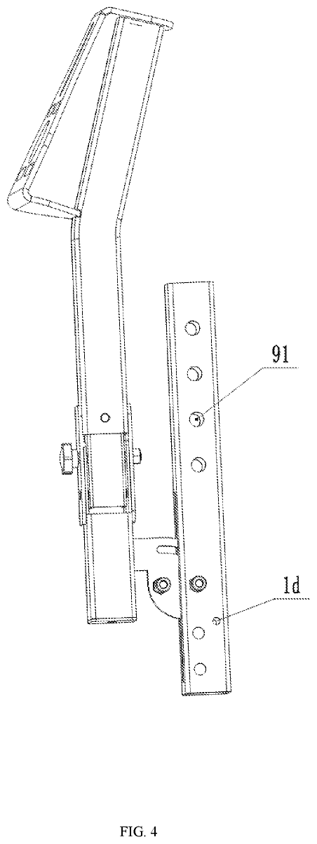

When shipping, the movable bar frame assembly can be folded, as shown in FIG. 4, and the locking member 10 can be selectively screwed into the locking hole 1d to ensure the stability of the folded structure.

For the use state, please refer to FIG. 1. The movable square pipe is connected to the drag bar of the chassis (the distance is adjusted through the adjusting hole to avoid interference with the trunk), and the movable bar frame assembly and the fixed frame assembly are not folded, wherein the movable bar assembly locks the adjusting plate and the movable square pipe in the use state through at least one locking member, and the locking of the fixed frame assembly is as follows:

1. wo bolts are respectively inserted in the upper hole position and the lower hole position;

2. one bolt penetrates the lower hole and one bolt penetrates the rotation limiting hole;

3. one bolt penetrates the upper hole and one bolt penetrates the rotation limiting hole;

4. a bolt is inserted in the lower hole position, the screw of a bolt is screwed in the rotation limiting hole position, and the nut is welded on the side of the reinforcing plate;

5. a bolt passes through the upper hole, the screw of the bolt is screwed in the rotation limiting hole, and the nut is welded on the side of the reinforcing plate.

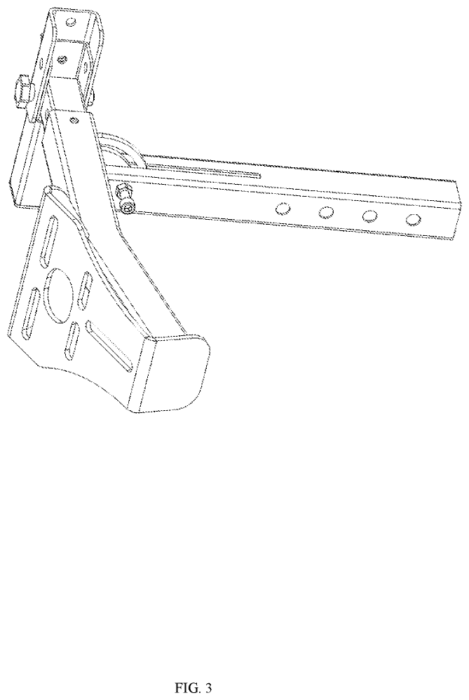

When the spare tire needs to be disassembled, the fixed frame assembly is folded, and the folded state is shown in FIG. 3. At this time, the spare tire is in contact with the ground and supported by the ground. Different ways of unlocking the fixed frame assembly are different, but for those skilled in the field, unlocking does not require any mental work, so it will not be described in detail here.

The above is only the preferred embodiment of the present disclosure, and it is not intended to limit the present disclosure. For those skilled in the art, the present disclosure can be modified and varied. Any modification, equivalent substitution, improvement, etc. made within the spirit and principle of the present disclosure shall be included in the scope of protection of the present disclosure.

What is claimed is:

1. A two-way foldable spare tire rack for a vehicle, comprising a fixed frame assembly for fixing a spare tire and a movable bar frame assembly arranged at one side of the fixed frame assembly, characterized in that:
the fixed frame assembly comprises a positioning joint pipe, a support pipe arranged above the positioning joint pipe, a rotating member and a rotation limiting member, wherein the positioning joint pipe and the support pipe form a rotatable structure through the rotating member, and the rotation limiting member is used for limiting the rotation between the support pipe and the positioning joint pipe to keep them in a use state; a long bracket pipe is fixed above the support pipe, and a bracket plate is fixed at a free end of the long bracket pipe;
the movable bar frame assembly comprises an adjusting plate, a movable square pipe and at least one locking member which are rotationally connected, wherein the adjusting plate is fixedly connected to one side of the positioning joint pipe, and the locking member is used for locking the adjusting plate and the movable square pipe in the use state.

2. The two-way foldable spare tire rack for a vehicle according to claim 1, characterized in that the rotating member and the rotation limiting member are bolts of a same size, and the positioning joint pipe and the support pipe are provided with an upper hole position and a lower hole position at the overlapping position that are perforative for two bolts to pass through.

3. The two-way foldable spare tire rack for a vehicle according to claim 2, characterized in that the cross-sectional size of the support pipe is smaller than that of the positioning joint pipe, the cross-sectional size of the long bracket pipe is consistent with that of the positioning joint pipe, and an upper end of the positioning joint pipe is also provided with a reinforcing plate with a U-shaped cross section, and the upper hole position and the lower hole position simultaneously penetrate through the reinforcing plate.

4. The two-way foldable spare tire rack for a vehicle according to claim 3, characterized in that the overlapping position of the long bracket pipe and the reinforcing plate is provided with a rotation limiting hole position for one of the bolts to pass through.

5. The two-way foldable spare tire rack for a vehicle according to claim 4, characterized in that a nut of one of the bolts can be welded on the side of the reinforcing plate.

6. The two-way foldable spare tire rack for a vehicle according to claim 1, characterized in that there are two locking members, and when in use, the two locking members pass through the overlapping part of the adjusting plate and the movable square pipe.

7. The two-way foldable spare tire rack for a vehicle according to claim 1, characterized in that a locking hole is formed on the movable square pipe or/and the adjusting plate, and the locking member can be inserted into the locking hole to lock the adjusting plate and the movable square pipe in a folded state.

8. The two-way foldable spare tire rack for a vehicle according to claim 1, characterized in that the movable square pipe is provided with a plurality of adjusting holes at equal intervals in a length direction.
